(19) United States
(12) Patent Application Publication
(10) Pub. No.: US 2012/0311279 A1
(43) Pub. Date: Dec. 6, 2012

(54) DATA RECOVERY AND BACKUP SYSTEM AND PROCESS

(75) Inventors: John H. Hong, Irvine, CA (US); Richard Sarner, Irvine, CA (US)

(73) Assignee: TOSHIBA AMERICA INFORMATION SYSTEMS, INC., Irvine, CA (US)

(21) Appl. No.: 13/152,187

(22) Filed: Jun. 2, 2011

(51) Int. Cl. G06F 12/16

(52) U.S. Cl. 711/162; 711/E12.103

(57) ABSTRACT

Certain embodiments relate to an information processing apparatus and a data rescue method that makes it possible to restore an operating system while preserving certain user data on the same partition as the operating system. The system may identify a directory, prior to booting to an operating system located on a first partition, the directory comprising user files. The directory may be located on the first partition. The system may rename the user directory to a unique identifier to ensure its preservation during the recovery process.

### TECHNICAL FIELD

The systems and methods disclosed herein relate generally to systems and methods for restoring a computer system to a basic state while retaining certain user-specified content.

### BACKGROUND OF THE INVENTION

Computer systems perform various types of processing using operating systems, applications, data created by the applications, and the like on a memory system such as a hard disk drive or solid state drive. Unfortunately, portions of the operating system in memory may be corrupted or damaged, either, for example, via internal defects or malware. Even though the memory hardware may itself be functioning properly, as the operating system has been compromised the computer cannot be used. Previously, users have reinstalled the operating system to again place the computer in a usable state. Unfortunately, this recovery process generally restores the computer to a default state which is not tailored to the particular information needs of the user.

Accordingly, it would be desirable for a user to have access to a method for preserving their personal data while still permitting a recovery of the operating system. Furthermore, it would be desirable to retain the user's data without relocating the user data between partitions as this prolongs the recovery process, introduces opportunities for error, and introduces additional security risks when the user data is intended to remain confidential.

### SUMMARY OF THE INVENTION

Certain embodiments contemplate a method for recovering an operating system, implemented using one or more computer processors, the method comprising: identifying a first directory, prior to booting to an operating system located on a first partition, the first directory comprising user files, the first directory located on the first partition; renaming the first directory to a renamed directory; removing all user files on the first partition except the user files located in the renamed directory; and copying one or more operating system recovery files to the first partition.

In certain embodiments the method further comprises copying files to the first directory while the operating system is booted. In certain embodiments the method further comprises removing all files and directories on the first partition except the renamed directory. In certain embodiments to remove all files and directories means to overwrite all files and directories. In certain embodiments the operating system recovery files comprise image files. In some embodiments, the method comprises presenting a user with dialog boxes, the dialog boxes comprising modifications to the WinRE environment.

Certain embodiments contemplate a non-transitory computer-readable medium comprising instructions configured to cause one or more processors to perform the steps of: identifying a first directory, prior to booting to an operating system located on a first partition, the first directory comprising user files, the first directory located on the first partition; renaming the first directory to a renamed directory; removing all user files on the first partition except the user files located in the renamed directory; and copying one or more operating system recovery files to the first partition.

Certain embodiments further comprise copying files to the first directory while the operating system is booted. Certain embodiments further comprise removing all files and directories on the first partition except the renamed directory. In certain embodiments, to remove all files and directories means to overwrite all files and directories. In certain embodiments the operating system recovery files comprise image files. In certain embodiments, the method comprises presenting a user with dialog boxes, the dialog boxes comprising modifications to the WinRE environment.

Certain embodiments contemplate an electronic device comprising: a non-transitory computer-readable medium comprising instructions configured to cause one or more processors to perform the steps of: identifying a first directory, prior to booting to an operating system located on a first partition, the first directory comprising user files, the first directory located on the first partition; renaming the first directory to a renamed directory; removing all user files on the first partition except the user files located in the renamed directory; and copying one or more operating system recovery files to the first partition.

Certain embodiments further comprise copying files to the first directory while the operating system is booted. Certain embodiments further comprise removing all files and directories on the first partition except the renamed directory. In certain embodiments, to remove all files and directories means to overwrite all files and directories. In certain embodiments, the operating system recovery files comprise image files. In certain embodiments the method comprises presenting a user with dialog boxes, the dialog boxes comprising modifications to the WinRE environment.

Certain embodiments contemplate a method, implemented using a least one computer processor, for providing a modified recovery process to a user comprising: running a first portion of a script file, the script file previously modified to comprise one or more command line calls to at least one of a plurality of executable tools; modifying at least one resource stored in a random access memory using at least one of the plurality of executable tools; and generating a modified dialog box, the modified dialog box including at least one option generated based on said running a portion of the script file and said modifying at least one resource, wherein the at least one option is associated with not executing a second portion of the script file.

In certain embodiments, the second portion of the script file comprises a command line instruction to format at least a portion of a partition.

### BRIEF DESCRIPTION OF THE DRAWINGS

FIG. 1 illustrates an electronic device of certain embodiments.

FIG. 2 is a schematic diagram of certain relations between various components of the electronic device of FIG. 1.

FIG. 3 is a diagram illustrating certain of the various partitions of certain embodiments of the memory of the electronic device of FIG. 1.

FIG. 4 is an illustration of an entry level menu screen presented to the user during operation of certain of the embodiments.

FIG. 5 is an illustration of a selection menu presented to the user for selecting between the default recovery, user recovery, and erasure operations as presented in certain embodiments.

FIG. 6 is a logical flow diagram depicting certain steps of the various recover operations as presented in certain of the embodiments.

FIG. 7 is an illustration of a selection menu presented to the user for selecting between various operations within the default recovery operation.

FIG. 8 is a logical flow diagram depicting certain steps of an embodiment of the user recovery operation in greater detail.

FIG. 9 is an illustration of certain of the relationships between various components of the recovery system.

FIG. 10A is an illustration of a warning screen presented to the user prior to using certain of the modification techniques presented herein.

FIG. 10B is an illustration of a modified version of the warning screen of FIG. 10A using certain of the modification techniques presented herein.

FIG. 11 is an illustration of a warning screen presented to the user in certain embodiments of the user recovery operation using certain of the modification techniques presented herein.

### DETAILED DESCRIPTION

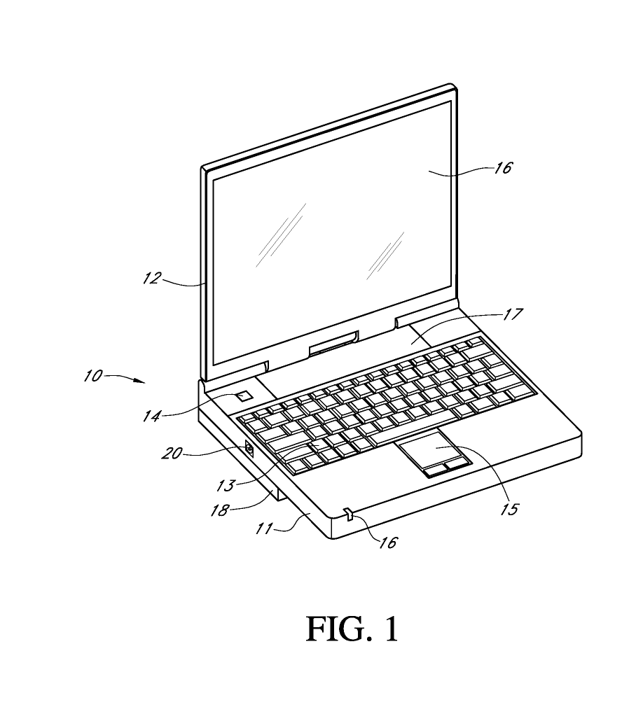

FIG. 1 illustrates an electronic device of certain of the disclosed embodiments. In this particular figure the electronic device is depicted as a portable notebook-sized personal computer 10, but one skilled in the art will readily recognize that any electronic device comprising a memory and operating system may also be suitable. FIG. 1 is a perspective view of the computer 10 viewed from the front side. A display unit 12 attached to the computer is in an open position. The computer 10 may be configured to receive power (electric power) from a first battery 17 and second battery 18. The first battery 17 and second battery 18 may have characteristics different from each other.

This computer 10 further comprises a computer main body 11 and display unit 12. In the illustrated embodiment a Liquid Crystal Display (LCD) 16 is incorporated in the display unit 12. The display unit 12 may be supported on the computer main body 11. The display unit 12 may be attached to the main body 11 rotatable between an opened position at which the top surface of the computer main body 11 is exposed, and closed position at which the top surface of the computer main body 11 is covered with the display unit 12. The computer main body may include a thin box-like housing and, on the top surface thereof, a keyboard 13, power switch 14 used to turn on/off the power of the computer 10, and touch pad 15 may be arranged.

Further, the computer main body 11 may comprise a power connector 20. The power connector 20 is provided on the side surface of the computer main body 11, for example, the left side surface thereof. An external power-supply is detachably connected to the power connector 20. As the external power-supply, an AC adapter may be used. The AC adapter is a power-supply configured to convert the commercial power (AC power) into DC power.

The power connector 20 may comprise a jack to which a power plug derived from the external power-supply can be detachably connected. The first battery 17 may be detachably attached to the computer main body 11 at, for example, a rear-end part thereof. On the other hand, the second battery 18 may be detachably attached to the computer main body 11 at, for example, an underside part thereof. The first battery 17 may be incorporated in the computer 10, and second battery 18 may be an optional battery which can be attached to the computer 10 as the need arises.

The computer 10 may be driven by the power from the external power-supply, power from the first battery 17 or power from the second battery 18. When the external power-supply is connected to the power connector 20 of the computer 10, the computer 10 may be driven by the power from the external power-supply. Further, the power from the external power-supply may also be used to charge the first battery 17 or the second battery 18. Charging of the first battery 17 or the second battery 18 may be carried out not only while the computer 10 is powered on, but also while the computer 10 is powered off. While the external power-supply is not connected to the power connector 20 of the computer 10, the computer 10 is driven by the power from the first battery 17 or the power from the second battery 18.

Further, the computer main body 11 is provided with an indicator 16 configured to notify various power-supply statuses such as presence/absence of the external power-supply and the like. The indicator 16 is provided at a position, for example, in front of the computer main body 11. In some embodiments the indicator 16 may be a light emitting diode (LED).

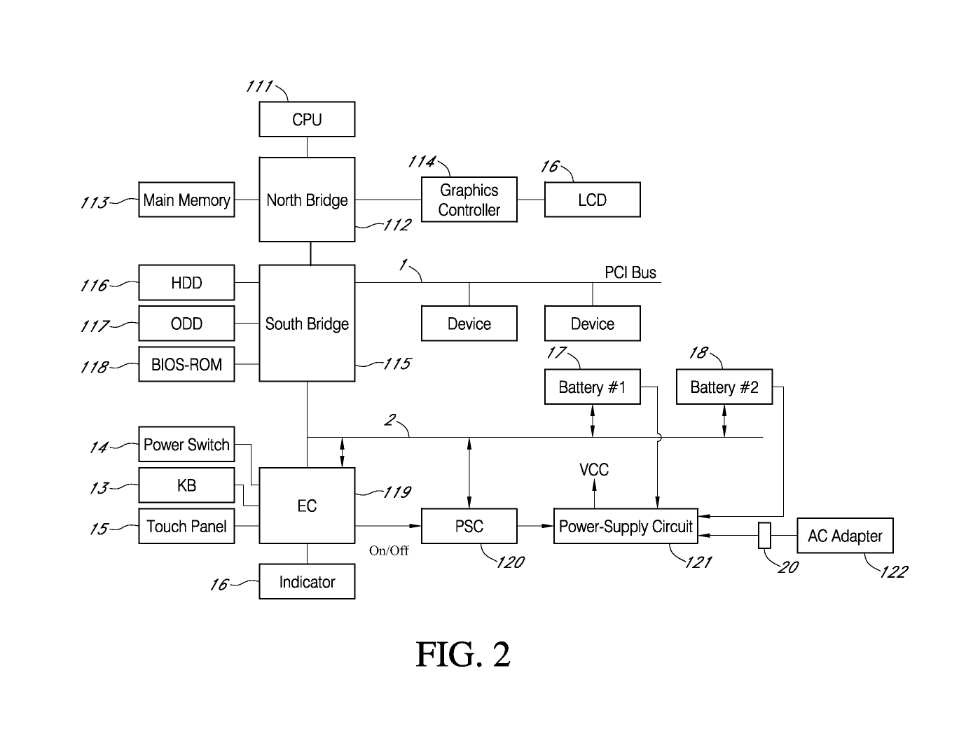

FIG. 2 is a schematic diagram of certain relations between various components of the electronic device of FIG. 1. Although certain of the components and relationships therebetween are illustrated in this figure one will readily recognize a plurality of other components and relationship not shown, or relationships which may be omitted in alternative embodiments. The computer 10 comprises a CPU 111, north bridge 112, main memory 113, graphics controller 114, south bridge 115, hard disk drive (HDD) 116, optical disk drive (ODD) 117, BIOS-ROM 118, embedded controller (EC) 119, power-supply controller (PSC) 120, power-supply circuit 121, AC adapter 122, and the like. The AC adapter 122 is used as the above-mentioned external power-supply.

The CPU 111 may be a processor configured to control operations of various components of the computer 10. The CPU 111 executes various software items loaded from the HDD 116 into the main memory 113, for example, an operating system (OS) and various application programs. Further, the CPU 111 may also execute a Basic Input Output System (BIOS) stored in the BIOS-ROM 118 which may be a nonvolatile memory. The BIOS may be a system program for hardware control.

The north bridge 112 may be a bridge device configured to connect a local bus of the CPU 111 and the south bridge 115 to each other. Further, the north bridge 112 also has a function of executing communication with the graphics controller 114. Furthermore, a memory controller configured to control the main memory 113 may be incorporated in the north bridge 112. The graphics controller 114 may be a display controller configured to control the LCD 16 to be used as a display monitor of the computer 10.

The south bridge 115 may be connected to a PCI bus 1, and executes communication with devices on the PCI bus 1. Further, an Integrated Drive Electronics (IDE) or Serial ATA controller configured to control the hard disk drive (HDD) 116 and optical disk drive (ODD) 117 are incorporated in the south bridge 115.

The EC 119, power-supply controller (PSC) 120, and batteries 17, 18 may be connected to each other through a serial bus 2 such as an I2C bus. The embedded controller (EC) 119 is a power management controller configured to execute power control of the computer 10, and may be realized as, for example, a one-chip microcomputer in which a keyboard controller configured to control the keyboard (KB) 13, touch pad 15, and the like is incorporated. The EC 119 has a function of turning on/off the power of the computer 10 in accordance with an operation of the power switch 14 carried out by the user. Control of turning on/off of the power of the computer 10 is executed by a cooperative operation of the EC 119 and power-supply controller (PSC) 120. Upon receipt of an ON signal transmitted from the EC 119, the power-supply controller (PSC) 120 controls the power-supply circuit 121 to turn on the power of the computer 10. Further, upon receipt of an OFF signal transmitted from the EC 119, the power-supply controller (PSC) 120 controls the power-supply circuit 121 to turn off the power of the computer 10. Even while the computer 10 is in the off-state, the EC 119, power-supply controller (PSC) 120, and power-supply circuit 121 operate by the power from the battery 17 or 18 or the AC adapter 122.

The power-supply circuit 121 produces power (operating power) to be supplied to the various components by using the power from one of the batteries 17 and 18 attached to the computer main body 11 or power from the AC adapter 122 to be connected to the computer main body 11 as the external power-supply. If the AC adapter 122 is connected to the computer main body 11, the power-supply circuit 121 produces the operating power to be supplied to the components by using the power from the AC adapter 122, and charges the battery 17 or 18 by turning on a charging circuit.

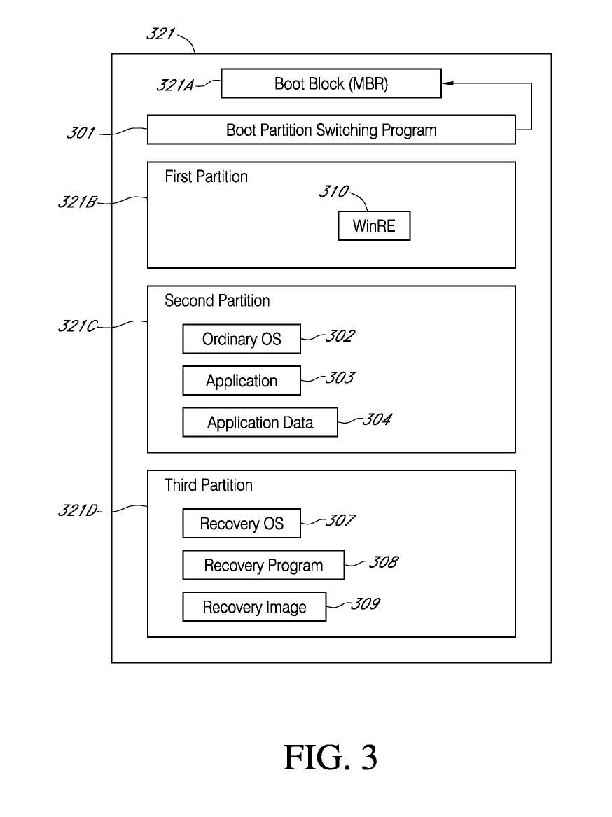

FIG. 3 illustrates certain of the various partitions in a memory, such as within the HDD 116 of the electronic device of FIG. 1. As shown in FIG. 3, the hard disk drive partitions 321 may comprise a boot block 321A called a master boot record (MBR), a first partition 321B, a second partition 321C, and a third partition 321D. The boot block 321A may provide an environment for the system to recognize an active partition on start up. The system may reference a partition table in the boot block 321A and then boot the system from an identified active partition.

A boot partition switching program 301 may be used to allow the user to identify a desired active partition. The active partition comprises the partition to which the system will boot once initiated. The switching program 301 may inquire of the BIOS program in the BIOS-ROM 118 which partition the system is to be booted from when the boot partition switching program 301 is called (booted) from the BIOS program in the BIOS-ROM 118. Upon receiving a reply, the boot partition switching program 301 may set the a specific partition (pre-configured) as an active partition (and change the other partitions to inactive partitions) in the partition table of the boot block 321A.

The first partition 321B may comprise the “Windows Recovery Environment” (WinRE) OS partition 310. The WinRE partition's primary function may be to boot the system to the ordinary operating system located in the second partition 321c. The WinRE partition may also provide for the repair or recovery launch of the ordinary operating system 302 when it is damaged. Although the first partition is referred to herein as the WinRE partition, alternative recovery partitions associated with operating systems other than Windows are also possible in certain other embodiments.

Particularly, one will readily recognize a plurality of ordinary operating systems that may reside in the second partition 321C, such as Windows. In addition to the ordinary operating system 302, user data 304 created using an application 303 may be stored in the second partition 321C. The third partition 321D may comprise a recovery operating system 307 and a recovery program 308 booted for restoring the first and second partitions 321B and 321C to the state at the factory default (initial state) and a recovery image 309 corresponding to the state of the first partition 321B and 321C at the state at the factory default.

If data in the ordinary operating system 302 is damaged or corrupted it may be impossible to boot to the ordinary operating system 302. Similarly, viruses and other malware programs may make it impossible to continue operation of the ordinary operating system 302 in its present form. Though the ordinary operating system 302 may operate improperly, the hard disk drive 321 may not have failed and may be operating in perfect condition. In such a case, it would be preferable for the user to be able to recover the ordinary operating system to a usable form, so that it may again operate effectively within the hard drive partition 321C. Furthermore, it would be preferable to efficiently retain as much of the user data 304 as the user desires, rather than simply discard the user's data as part of the recovery process.

Certain of the present embodiments contemplate a system and method for facilitating quick and efficient recovery of the ordinary operating system 302. Particularly, certain of these embodiments provide for efficient retention of user data during the recovery process, possibly by modifying a previously existing recovery tool. While previous systems may overwrite, delete, or relocate user data 304 as part of this recovery process, certain of the present embodiments advantageously contemplate systems and methods for retaining user data 304 on the first partition during the recovery operation. This not only decreases the risk of corrupting or losing user data 304, but also facilitates a more uniform recovery operation requiring few extraneous partitions or resources.

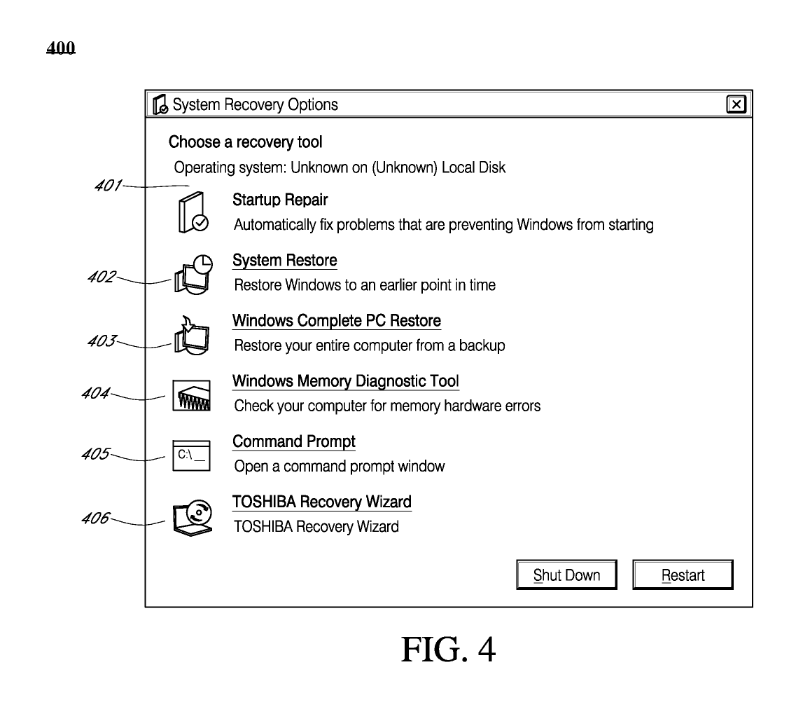

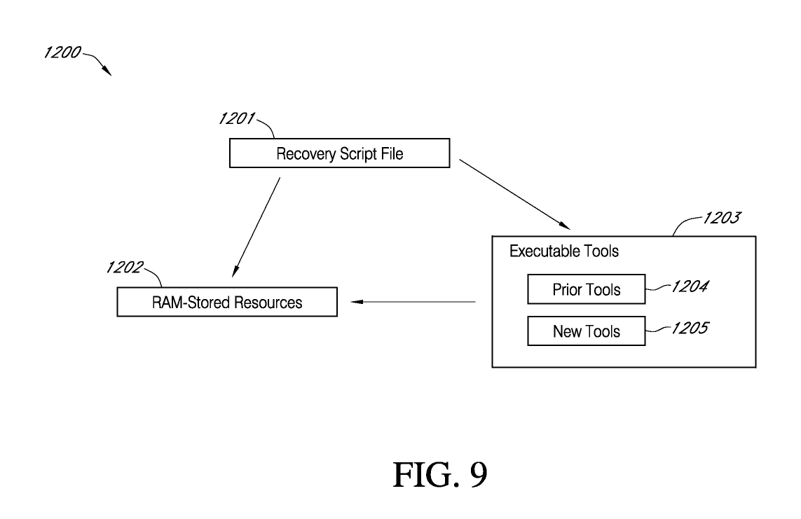

FIG. 4 is an illustration of an entry level menu screen presented to the user during operation of certain of the embodiments. In some embodiments this entry level screen is a modification of the menu screen of an entry-level WinRE screen using methods described in greater detail below with regard to FIG. 9. Certain of the present embodiments contemplate determining if the recovery process has been launched by making a selection from the WinRE menu, or if the process was launched directly via other means by the user. The recovery process may determine what information is to be gathered from the user based on the method of launch.

As one example, a user may initiate the WinRE by holding down the F8 key during powerup. The user may then be presented with the WinRE menu, in some embodiments the menu of FIG. 4. At this point the user may select the option “Toshiba Recovery Wizard” 406. In certain other embodiments the user may hold down the “0” key during power up and the MBR will boot the machine to the windows preinstallation environment (WinPE) partition (in the third partition 321D) and launch the “Toshiba Recovery Wizard” 406 automatically.

The user may be prompted with the screen of FIG. 4 after the machine is booted to WinRE. In this embodiment, the recovery option screen may comprise a plurality of traditional recovery tools and procedures 401-405. These may comprise, for example, a startup repair tool 401 which automatically seeks to fix problems that prevent the operating system from starting. The tools may also comprise a system restore tool 402, which attempts to revert the operating system configuration files and utilities to their state at a previous point in time, preferably before whatever undesirable event prompted the need for recovery. A complete restore tool 403 which simply reverts to a backup state, possibly from a user backup image, and a memory diagnostic tool 404 which attempts to pinpoint a hardware or firmware error in memory may also be provided. Some embodiments also contemplate a command prompt 405 to allow the user to perform any actions using a command prompt window. Certain of the above features may be included as part of a standard WinRE menu. Certain of the embodiments contemplate providing the user with an additional option at this time, the recovery wizard option 406 which facilitates recovery using the Toshiba Recovery method. This option may be added to the preexisting selection screen via a method outlined below with respect to FIG. 9.

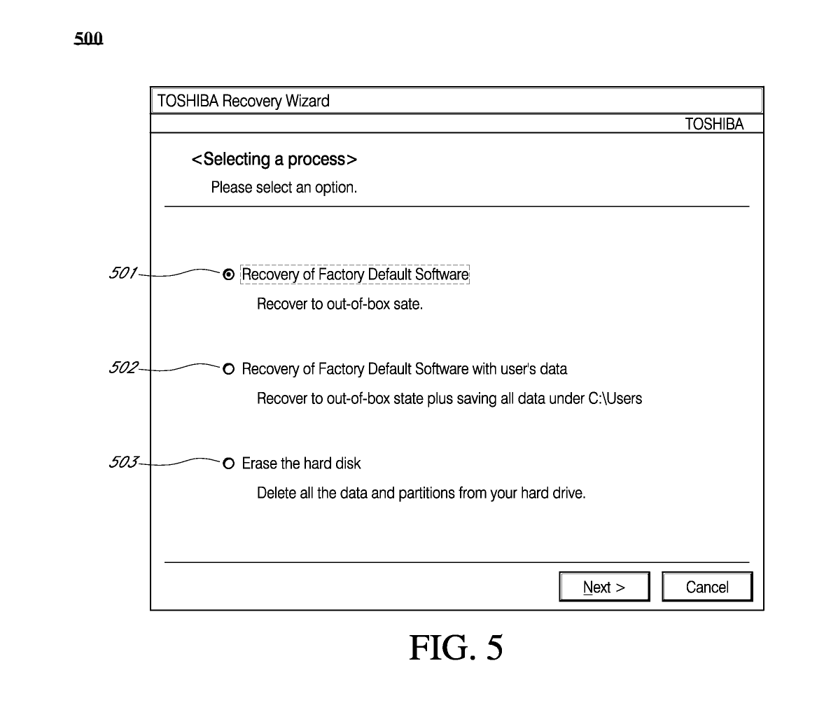

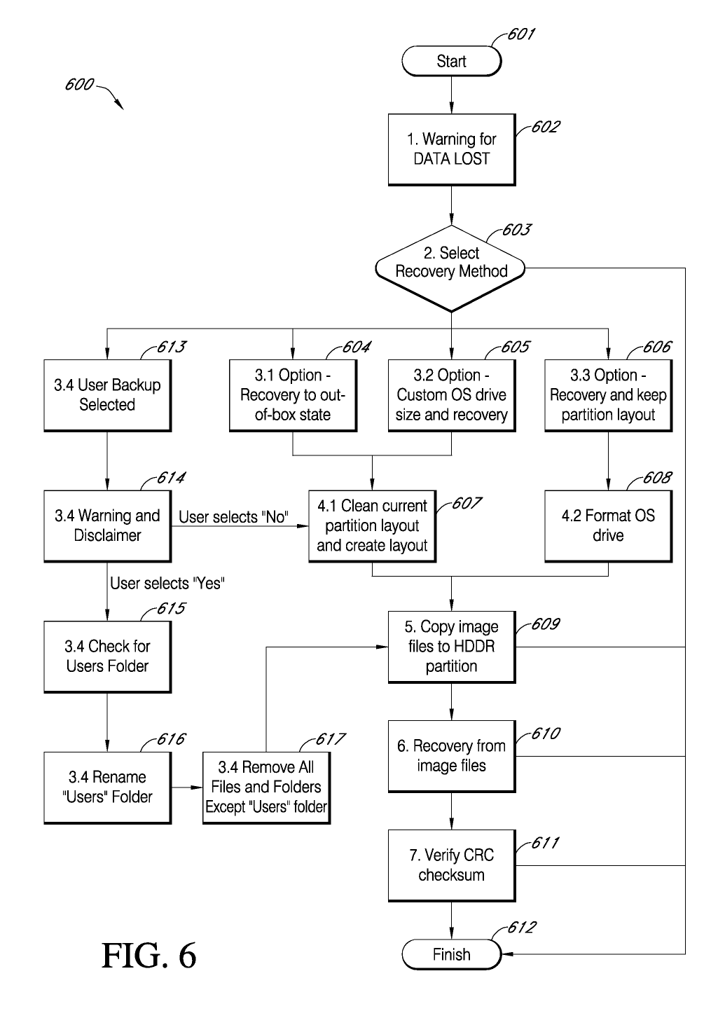

After selecting the recovery wizard option 406 the user may be presented with a selection menu as illustrated in FIG. 5. FIG. 5 is an illustration of a selection menu presented to the user comprising a radio button for selecting between the default recovery 501, user recovery 502, and erasure operation 503 as presented in certain embodiments. Again, this menu may comprise a modification of a preexisting menu from a preexisting recovery environment, such as WinRE. In these embodiments the menu may have been modified using a windows dialog engine. For example, the dialog boxes and menus may be produced using an existing recovery process dialog engine whose inputs have been adjusted as described in greater detail below with respect to FIG. 9. Using these methods, the default dialog box is modified to include item 502 as indicated by FIG. 5. The subsequent steps following from selecting each of these options are presented in greater detail with respect to the flow diagram of FIG. 6.

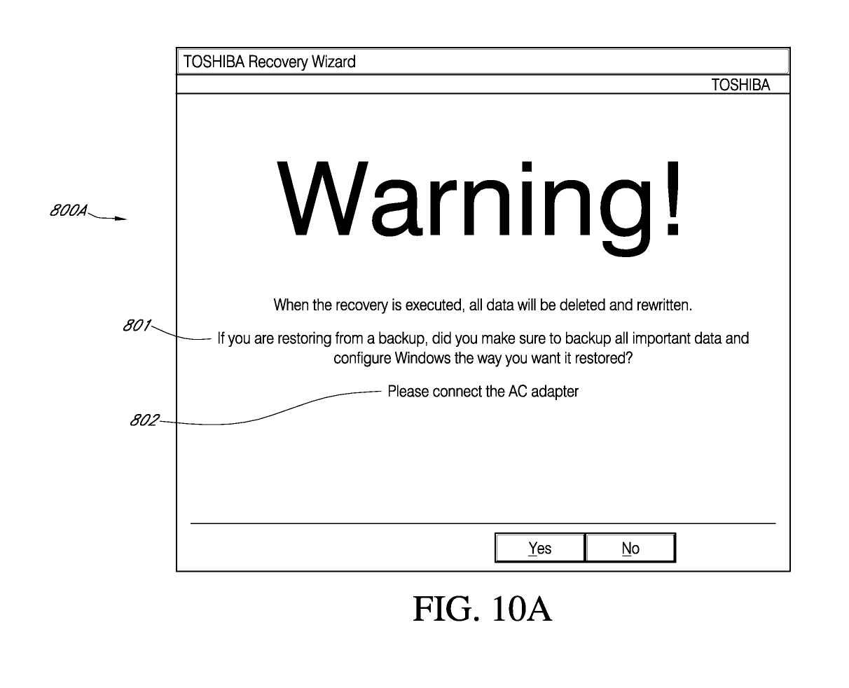

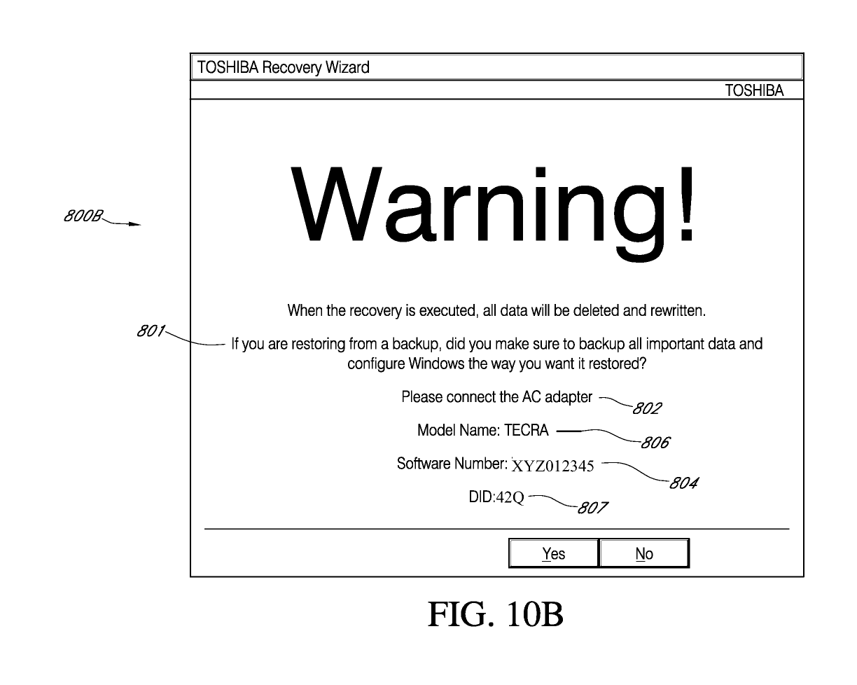

FIG. 6 illustrates the consequences of the user's selection in the menu of FIG. 5 in greater detail. As illustrated by the process 600 of FIG. 6, the system may begin 601 by warning the user that data loss may occur during recovery 602. This warning may be presented before or after presenting the menu of FIG. 4. FIG. 10B is an illustration of a warning screen 800B presented 602 to the user in certain embodiments during the default recovery operation. This warning screen may comprise a modification to a default warning screen 800A using the methods described below with respect to FIG. 9. Process 600 may then present the user with a selection menu for various recovery methods 603, such as the selection menu of FIG. 5.

If the user were to select the radio button 501 for recovery to the factory default software, the process 600 would proceed to step 604. In some embodiments, the user may be further presented with an option to specify certain features of the factory default and custom operating system installed during recovery and will accordingly be directed to step 605. As discussed above, the launch method used may dictate which of steps 604 and 605 occur next. If the user were to instead select the recovery process associated with the third radio button, erasure of the disk, the process 600 would proceed to the step 606 and then format the partition upon which the operating system is located 608. Each of these two methods does not seek to preserve the user's existing data on the partition.

Regardless of whether the first, second, or third option is selected, certain embodiments contemplate proceeding through the same recovery sub-process 609-612 once the partition has been adequately prepared. This sub-process may include copying and/or moving image files to the partition 609 and then initiating recovery of the operating system from the image files 610. Once recovery is complete, the system may initiate a cyclic redundancy check (CRC) checksum to verify the integrity of the newly installed operating system. In some embodiments the recovery utility may maintain an exclusion file used to exclude files and folders from the CRC check after the OS image has been recovered. It may not be necessary to modify the CRC check behavior when selecting a default recovery 501 or an erasure 503, but variations in the CRC method are described in greater detail below with regard to the user data process 502. After completing the reinstallation the process 600 may then end 612 and allow the system to boot normally. Certain embodiments contemplate receiving user confirmation during each step of the recovery subprocess 609-612 and returning to an earlier selection menu 603 or warning screen 602 based on the user's indications.

As mentioned previously, certain embodiments contemplate providing the user with a third recovery option, the user recovery operation as indicated by the radio button 502 in the selection menu of FIG. 5. Unlike the erasure 503 and factory default 501 processes, the user recovery operation seeks to return the ordinary operating system 302 to a functional state without erasing certain user data 304 or moving the user data 304 off the partition 321B. The user recovery option 502 is generally depicted by the sub-process 613-617 in FIG. 6.

User recovery option 502 contemplates that during normal operation of the operating system 302, the system or the user may periodically place files of importance to the user within a predetermined path, such as the “Users” directory in a Windows installation. In some embodiments an automated tool periodically copies or moves files to this location, whereas in other embodiments the user manually selects and places the files in this location. When the user subsequently requests that the user recovery operation be performed 502, the recovery system may make reference to this directory to determine which files and folders are to be preserved and retained on the partition 321C during and after the recovery process. Again, a different folder than the “User” folder may be specified as the folder for file preservation during recovery.

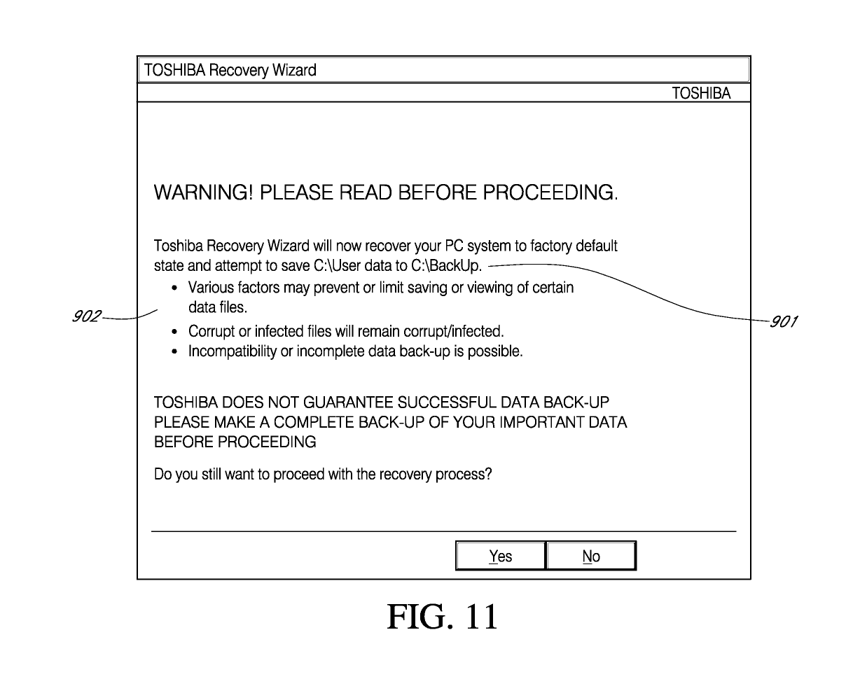

When the user selects the user recovery operation option 502 the system may then proceed to step 613 and provide a warning and disclaimer 614. Unlike the warning of FIG. 10B this warning, one example of which is illustrated in FIG. 11, may indicate that the recovery is to be performed while preserving the user data directory. This warning menu may also be generated by modifying a preexisting warning menu using the methods discussed below in relation to FIG. 9. If the user does not agree, then the process may be redirected to a typical recovery operation, such as cleaning of the current partition layout 607. If, instead, the user does agree, then the process 600 checks for existence of the user's folder 615. If the user's folder exists, the process 600 then renames the folder 616 to a form amenable to selective recovery. This may make it possible to change the user folder being saved, without making considerable modifications to the scripts and executables performing the subsequent steps. For example, the user may have been allowed to select the desired folder or folders to preserve, which are then collected into a single preservation folder which is renamed to the form more amenable to selective recovery. The system may then remove all files and folders except the preservation folder 617 before proceeding to the recovery sub-process 609-612.

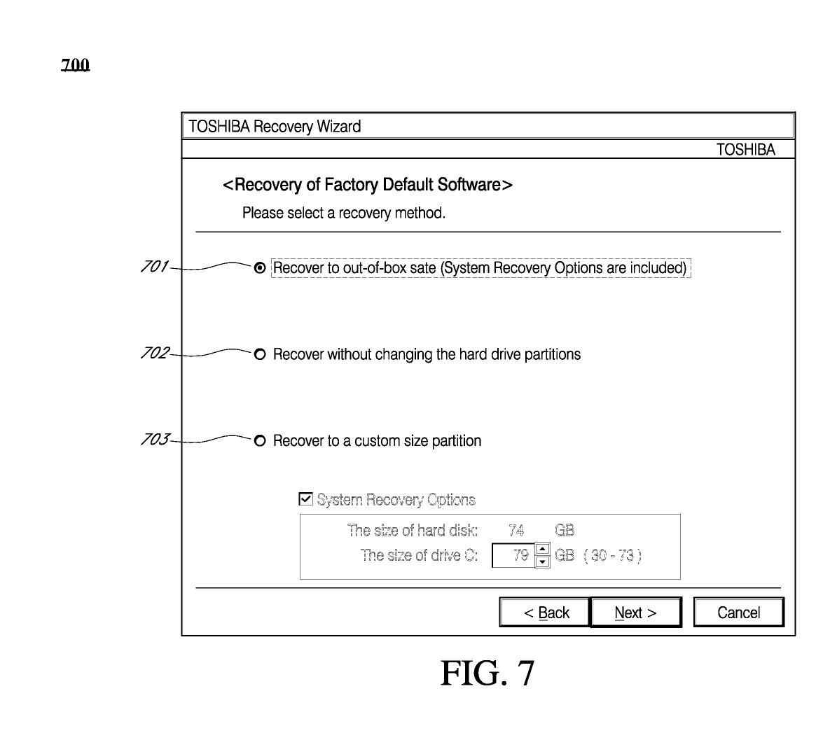

FIG. 7 is an illustration of a selection menu presented to the user for selecting between various operations within the default recovery operation. Such a menu may be presented to the user at step 607 and thus may be reached either by selecting the recovery of the factory default software 501 or by cancelling the user recovery option at step 614. As mentioned, the user may be allowed to specify whether they wish to recover the system to an out-of-the-box-state (OOBE) 701 which may place the system in a form roughly equivalent to that provided from the manufacturer. This may include removing or reformatting any extraneous partitions not originally part of the manufactured system, such as partition 321C. Some systems will even restore the boot block partition 321A and the switching program 301 to a default state. The user may instead choose to recover the system without removing the additional partitions 702. In this case, the system will seek to restore partition 321C, but not 321B. The system may also offer to adjust the partition sizes 703 as part of the recovery process. When selected, the user may then be presented with a size selection tool 704, such as a spinner input, before indicating that the process may proceed 705.

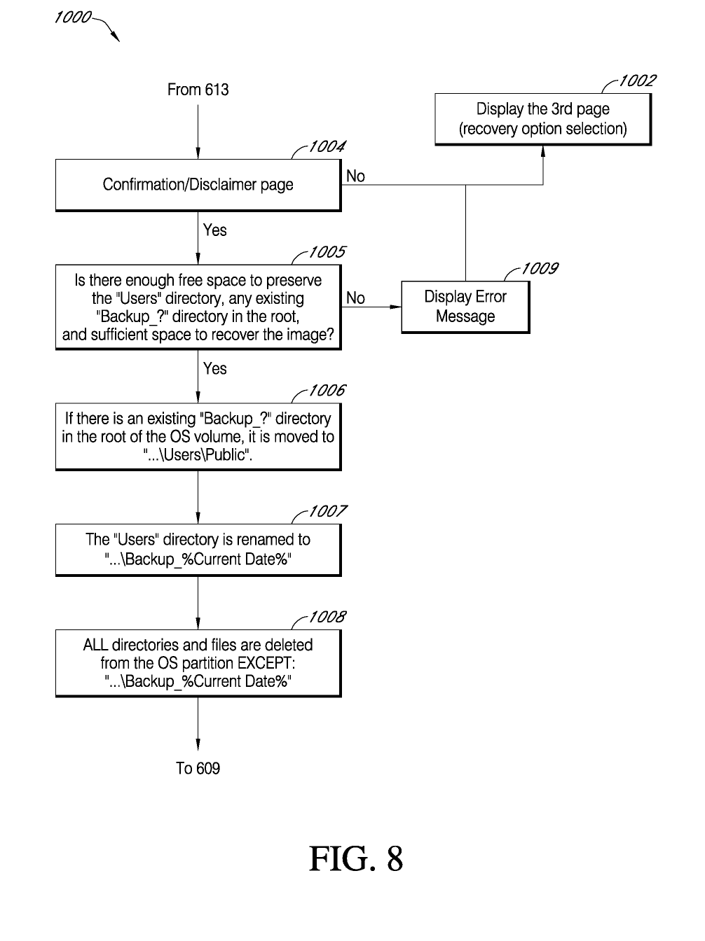

FIG. 8 is a logical flow diagram depicting certain steps of an embodiment of the user recovery operation, shown in steps 613-617 of FIG. 6 in greater detail. As discussed above, the process may present the user with a selection menu 603 and following the user's selection of the user recovery operation may then present the user with the confirmation/disclaimer screen 1004 of FIG. 11. If the user acknowledges the confirmation the system may then verify that sufficient free space exists to preserve the “users” directory, as well as any “backup_” directory data in the root. The system may also verify that there is sufficient space to recover the image. The size (in some embodiments the sum of all the file sizes) of this directory is then totaled. The available OS partition free space less the total amount of data in the “Users” directory may then be calculated. In some embodiments, if there is then insufficient free space to recover the factory image plus a padding amount, such as 10 GB, the system will post an error specific dialog 1009 stating the error and that the process cannot continue. This “padding” may be used to ensure there is sufficient free space to recover the image. The system may then revert back to the “normal” 1002 recovery options, such as Toshiba Recovery Wizard FIG. 5.

Thus, where sufficient free space exists the system may then proceed with preserving the user data 1005. Particularly, the system will move or rename the user directory such that the data will not be overwritten during the subsequent restoration procedures. This may be accomplished using a program such as ImageX. ImageX is a command-line tool that captures, modifies, and applies file-based disk images to a partition.

While ImageX is intended to be non-destructive, if the image to be subsequently uploaded (steps 609-610 of FIG. 6) contains a folder sharing an identical name to the “Users” directory, the data in that directory, which was intended to be preserved, will instead be overwritten. Thus, in certain of the embodiments where the “Users” folder is renamed, the new folder name comprises a unique identifier to avoid the folder's being overwritten during the image restoration subprocess.

For example, a windows “User” directory may be renamed to a directory comprising the prefix “Backup_” followed by a unique date identifier. The system may determine if a “Backup_” directory with the unique identifier already exists 1006 in the root of the OS partition 321B. If so, in some embodiments the backup directory is moved to the “ . . . \Users\Public” folder, possibly using a program such as ImageX, to preserve any data therein. The “Users” directory may then be renamed to “ . . . /Backup_%Current Date%” where %CurrentDate% represents an environment variable, or a variable local to the recovery process which contains the current date upon which the recovery is being performed. In some embodiments the “%CurrentDate%” variable may be obtained from the machine's real-time clock (RTC) and written in scientific notation “(DAY-MON-YEAR)”, for example “Backup_{—}28-Mar-11”. By appending the date of creation to the folder name, it is unlikely that the recovery image will contain a folder with the same name. The use of the %Current Date% variable is but one example and one will readily recognize other methods for creating a unique identifier for a directory, such as appending a hash of certain file data, etc.

One will recognize that the above operations, such as the changing of the directory names and folder locations, may be achieved either via a program such as ImageX or independently by manipulating an mode table, system registry, or similar file management structure of the ordinary operating system directly. ImageX, for example, may rebuild the master file tables (MFT) of the operating system once booted. If an end-user were to recover a machine more than once on the same day, in those embodiments where the unique identifier comprises a date, data would still be preserved since any existing “\Backup . . . ” folder is first moved to “\User's” sub-folder, such as “Users\Public”, and then the current “\Users” folder is renamed to “\Backup_” followed by the date.

The process may then delete all directories and files from the OS partition except the directory “ . . . /Backup_%Current Date%” 1008. In some embodiments, deletion means modifying the mode table or registry mentioned above such that the data contained in folders outside “ . . . /Backup_%Current Date%” is no longer referenced by the operating system, but the data itself is not directly overwritten on the hard drive. In other embodiments, the data is overwritten, possibly multiple times, as part of the deletion process with an arbitrary string of data to ensure removal. In some embodiments, since the partition schemes are not altered when this utility runs, the volume label of the machine may be acquired from the recovery system's information file and used to reset the volume label of the OS partition.

As discussed above, the sub-process 609-612 may initiate a CRC checksum 611 to verify the integrity of the newly installed operating system. In some embodiments the recovery utility may maintain an exclusion file used to exclude files and folders from the CRC check after the OS image has been recovered. Certain of the present embodiments contemplate amending the exclusion file to include the name of the directory (possibly “/Backup_%Current Date%”) in order to prevent a CRC failure. In some embodiments, if the exclusion file comprises a preexisting file residing in the random access memory (RAM), an executable program may dynamically update the file as it appears in RAM with the name of the “Backup . . . ” folder to be excluded from the overwrite operations.

As mentioned, certain embodiments contemplate using low-level backup recovery processes to perform the steps of FIGS. 6 and 8. For example, certain embodiments contemplate performing the described operations using a command-line tool, such as Image X (IMAGEX.EXE), which permits one to capture, modify, and to apply file-based disk images. Certain embodiments contemplate modifying a preexisting program, such as ImageX, to achieve the desired functionality. This new program (TOSIMAGEX.EXE) may then be called by another modified recovery program (TOSRECOVERY.EXE). In turn, a script file run on startup may be modified to include command line references to the recovery program. For these operations the command line syntax for initiating the procedures may be:

“START/WAIT TOSRECOVERY.EXE/CMD=APPLY/LOGLEVEL=2”

FIG. 9 illustrates the various relationships between certain of the system components which facilitate the above recovery processes by modifying the functionality of certain preexisting system components. As mentioned, the system may originally be configured to provide only two options, 501 and 503 for system recovery. Once the system boots, a recovery script file 1201 (RECOVERY.BAT in certain Windows implementations) may be run. This batch file issues calls to various pre-existing executable tools 1204. These tools may comprise, for example, system commands to generate window displays, perform file operations, and perform operations on the disk. For example, one executable “TOSDIALOG.EXE” is a dialog engine which dynamically generates dialog boxes throughout the recovery process, similar to those shown in FIGS. 4, 5, and 7. This executable may make reference to resources stored in random access memory (RAM) 1202. These resources may have been loaded previously upon boot, or via a call to an executable process 1203. The resources may comprise image artifacts such as buttons, background frames, characters, and other graphical images and text. The executable “TOSDIALOG.EXE” may also receive as input data obtained from the file “MESSAGE.INI”, which may provide the text and dialog box “type” info by which messages are displayed. Other “prior tools” may comprise TOSIMAGEX.EXE and TOSRECOVERY.EXE. The system will proceed through each instruction of the script file 1201 until all the required recovery operations are complete.

Certain of the present embodiments contemplate modifying the above system components to implement the third, user-preserving, recovery process 502. Particularly, new executable tools 1205 are provided which perform modified operations and adjust the content of the RAM-stored resources 1202 to facilitate the user-preserving recovery process 502. Also, the recovery script file 1201 may be modified to include and/or omit instructions, so as to implement the process flow 600 of FIG. 6. The amended recovery script file 1201 may make reference to new tools 1205. These new tools may comprise a modified version of IMAGEX.EXE (TOSIMAGEX.EXE). Certain of these tools may interact with each other, such as when one tool calls another. One will recognize that these tools 1203 may be located on the third partition 321D with the recovery program 308 in certain of the embodiments.

FIG. 10A is an illustration of a default warning screen 800a presented to a user prior to the modifications discussed with respect to FIG. 9. While the warning screen 800A puts the user on notice, providing informational messages 801 and 802, it would be beneficial to provide further information regarding the state of the system.

Accordingly, pursuant to the modifications to the recovery script 1201 and new tools 1205 described with respect to FIG. 9 the default warning screen 800a may be adjusted to include additional information. Particularly, the recovery script 1201 may be modified to make a call to an executable tool 1203 which may read relevant information, such as the DMI and Volume label of the OS partition. The system may record these values and append them to the default warning screen as indicated in FIG. 10B to display the machine's information, such as the Model Name (DMI Model Name, 806), DMI Download ID (DID, 807), and Software Number (OS Volume Label, 804) to the user. In some embodiments these modifications may provide fundamental information to product support personnel assisting the customer during the recovery process. The information may be appended to the warning screen dialog by modifying a resources file in RAM 1202, calling a dialog engine with different parameters via a modification to the script 1201, or using a new tool 1205 which may modify the RAM-stored resource 1202.

FIG. 11 is an illustration of a warning screen 900 presented to the user in certain embodiments during the user recovery operation. As discussed above, this screen may have been modified, using the methods discussed with respect to FIG. 9, to provide an indication of the directory 901 which is to be preserved during the user recovery operation. In other embodiments, the user may be provided with an opportunity to select the directory to be preserved at this time. The dialog may also be modified to provide an explanation 902 that unlike the other recovery processes, this recovery process will not remove corrupted files within the designated directory and may also result in an incomplete back-up. The user may then decide whether to proceed 903 or to return 904 to one of the previous recovery procedures, for example via the transition from block 614 to block 607 in FIG. 6.

The terms “directory” and “folder” are used interchangeably herein. As used herein, an “input” can be, for example, data received from a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

The invention is operational with numerous other general purpose or special purpose computing system environments or configurations. Examples of well-known computing systems, environments, and/or configurations that may be suitable for use with the invention include, but are not limited to, microcontrollers, personal computers, server computers, hand-held or laptop devices, multiprocessor systems, microprocessor-based systems, programmable consumer electronics, network PCs, minicomputers, mainframe computers, distributed computing environments that include any of the above systems or devices.

As used herein, “instructions” refer to computer-implemented steps for processing information in the system. Instructions can be implemented in software, firmware or hardware and include any type of programmed step undertaken by components of the system.

A “microprocessor” or “processor” may be any conventional general purpose single- or multi-core microprocessor such as a Pentium® processor, Intel® Core™ a 8051 processor, a MIPS® processor, or an ALPHA® processor. In addition, the microprocessor may be any conventional special purpose microprocessor such as a digital signal processor or a graphics processor. A “processor” may also refer to, but is not limited to, microcontrollers, field programmable gate arrays (FPGAs), application-specific integrated circuits (ASICs), complex programmable logic devices (CPLDs), programmable logic arrays (PLAs), microprocessors, or other similar processing devices.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

Certain embodiments of the system may be used in connection with various operating systems such as MICROSOFT WINDOWS®.

Certain embodiments of the system may be written in any conventional programming language such as assembly, C, C++, BASIC, Pascal, or Java, and run under a conventional operating system.

In addition, the modules or instructions may be stored onto one or more programmable storage devices, such as FLASH drives, CD-ROMs, hard disks, and DVDs. One embodiment includes a programmable storage device having instructions stored thereon.

While the above processes and methods are described above as including certain steps and are described in a particular order, it should be recognized that these processes and methods may include additional steps or may omit some of the steps described. Further, each of the steps of the processes does not necessarily need to be performed in the order it is described.

While the above description has shown, described, and pointed out novel features of the invention as applied to various embodiments, it will be understood that various omissions, substitutions, and changes in the form and details of the system or process illustrated may be made by those skilled in the art without departing from the spirit of the invention. As will be recognized, the present invention may be embodied within a form that does not provide all of the features and benefits set forth herein, as some features may be used or practiced separately from others.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors or circuitry or collection of circuits, e.g. a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

What is claimed is:

1. A method for recovering an operating system, implemented using one or more computer processors, the method comprising:
identifying a first directory, prior to booting to an operating system located on a first partition, the first directory comprising user files, the first directory located on the first partition;
renaming the first directory to a renamed directory;
removing all user files on the first partition except the user files located in the renamed directory; and
copying one or more operating system recovery files to the first partition.

2. The method of claim 1, further comprising copying files to the first directory while the operating system is booted.

3. The method of claim 1, further comprising removing all files and directories on the first partition except the renamed directory.

4. The method of claim 3, wherein to remove all files and directories means to overwrite all files and directories.

5. The method of claim 1, wherein the operating system recovery files comprise image files.

6. The method of claim 1, wherein the method comprises presenting a user with dialog boxes, the dialog boxes comprising modifications to the WinRE environment.

7. A non-transitory computer-readable medium comprising instructions configured to cause one or more processors to perform the steps of:
identifying a first directory, prior to booting to an operating system located on a first partition, the first directory comprising user files, the first directory located on the first partition;
renaming the first directory to a renamed directory;
removing all user files on the first partition except the user files located in the renamed directory; and
copying one or more operating system recovery files to the first partition.

8. The non-transitory computer-readable medium of claim 7, further comprising copying files to the first directory while the operating system is booted.

9. The non-transitory computer-readable medium of claim 7, further comprising removing all files and directories on the first partition except the renamed directory.

10. The non-transitory computer-readable medium of claim 9, wherein to remove all files and directories means to overwrite all files and directories.

11. The non-transitory computer-readable medium of claim 7, wherein the operating system recovery files comprise image files.

12. The non-transitory computer-readable medium of claim 7, wherein the method comprises presenting a user with dialog boxes, the dialog boxes comprising modifications to the WinRE environment.

13. An electronic device comprising:
a non-transitory computer-readable medium comprising instructions configured to cause one or more processors to perform the steps of:
identifying a first directory, prior to booting to an operating system located on a first partition, the first directory comprising user files, the first directory located on the first partition;
renaming the first directory to a renamed directory;
removing all user files on the first partition except the user files located in the renamed directory; and
copying one or more operating system recovery files to the first partition.

14. The electronic device of claim 13, further comprising copying files to the first directory while the operating system is booted.

15. The electronic device of claim 13, further comprising removing all files and directories on the first partition except the renamed directory.

16. The electronic device of claim 15, wherein to remove all files and directories means to overwrite all files and directories.

17. The electronic device of claim 13, wherein the operating system recovery files comprise image files.

18. The electronic device of claim 13, wherein the method comprises presenting a user with dialog boxes, the dialog boxes comprising modifications to the WinRE environment.

19. A method, implemented using a least one computer processor, for providing a modified recovery process to a user comprising:
running a first portion of a script file, the script file previously modified to comprise one or more command line calls to at least one of a plurality of executable tools;
modifying at least one resource stored in a random access memory using at least one of the plurality of executable tools; and
generating a modified dialog box, the modified dialog box including at least one option generated based on said running a portion of the script file and said modifying at least one resource,
wherein the at least one option is associated with not executing a second portion of the script file.

20. The method of claim 19, wherein the second portion of the script file comprises a command line instruction to format at least a portion of a partition.
